(19) United States
(12) Patent Application Publication
(10) Pub. No.: US 2026/0171540 A1
(43) Pub. Date: Jun. 18, 2026

(54) INTERCELL COOLING ELEMENT FOR ARRANGEMENT BETWEEN TWO CELL ROWS OF A BATTERY, BATTERY MODULE, MOTOR VEHICLE, AND METHOD FOR PRODUCING AN INTERCELL COOLING ELEMENT

(71) Applicant: AUDI AG, Ingolstadt (DE)

(72) Inventors: Carsten LORENZ, Reichertshofen (DE); Eduard MAIN, Buxheim (DE)

(73) Assignee: AUDI AG, Ingolstadt (DE)

(21) Appl. No.: 19/417,742

(22) Filed: Dec. 12, 2025

(30) Foreign Application Priority Data
Dec. 13, 2024 (DE) 102024137694.5

(51) Int. Cl. H01M 10/6556; B60L 50/64; B60L 58/26; H01M 10/613; H01M 10/625; H01M 10/647; H01M 10/6554; H01M 10/656

(52) U.S. Cl. CPC H01M 10/6556; H01M 10/613; H01M 10/625; H01M 10/647; H01M 10/6554; H01M 10/656; B60L 50/64; B60L 58/26; H01M 2220/20

(57) ABSTRACT

An intercell cooling element for arrangement between two cell rows, each having at least one battery cell, the intercell cooling element comprises a cooling plate including a first outer wall and a second outer wall opposite the same in a first direction. Between the first and second outer walls there is an interior space in which at least one cooling channel is arranged. The intercell cooling element includes at least one plastic component arranged on the outside of the cooling plate. A layered compression element compressible in the first direction is arranged in the interior of the cooling plate, and a layered stiffening element less compressible than the compression element is arranged in a second direction adjacent to the compression element.

### FIELD

The invention relates to an intercell cooling element for arrangement between two cell rows, each having at least one battery cell, wherein the intercell cooling element comprises a cooling plate, which comprises a first outer wall and a second outer wall opposite the same in a first direction, wherein an interior space is located between the first and second outer walls, in which interior space at least one cooling channel through which a cooling medium can flow is arranged, and wherein the intercell cooling element comprises at least one plastic component arranged on the outside of the cooling plate. Furthermore, the invention also relates to a battery module, a motor vehicle and a method for producing an intercell cooling element.

### BACKGROUND

Such an intercell cooling element can be arranged between two battery cells of a battery module or a battery. This allows the sides with the largest region of battery cells to be cooled. In addition, a plastic component can be arranged on the cooling plate of such an intercell cooling element. Such a plastic component can have different functions or be used for different purposes on the plastic plate. In order to attach such a plastic component to the cooling plate, which is often made of a metallic material, injection-molding it onto the cooling plate in an injection molding process represents a very simple and advantageous solution. In order for a coolant to flow through the cooling plate, it comprises at least one cooling channel, i.e. a kind of cavity in the interior between these two outer walls. In an injection process, however, such a cooling plate is subjected to different pressure loads, for example, on the one hand closing forces in the tool and, on the other hand, the injection pressure of the plastic melt. Above all, the pressure of the melt poses the risk of the cooling plate being damaged or deformed, the cooling channels being compressed and/or the melt then flowing, for example, under the tool or into slots or regions which arise as a result of such deformation.

DE 10 2006 053 654 A1 describes that it is possible in principle to provide the cavity of a profile with a pressure-stable filling, for example a core, during the injection molding process. However, this is technically complex and restricts the freedoms in shaping the profile. For example, a method for the production of injection-molded or pressed plastic parts is proposed according to DE 10 2006 053 654 A1, which parts are combined with one or more metallic hollow profiles during their forming process. In an injection or pressing tool for receiving an injection-molded or pressed plastic mass, a cavity is formed into which a connecting flange of the metallic hollow profile extends, wherein the or each metallic hollow profile is protected by sealing surfaces at the edge of the cavity against the pressing or injection forces of the plastic mass during the forming process.

However, this is only possible in the case of very specially designed hollow profiles or only in the case of special positioning of the component to be injected, namely if the injection-molded component to be produced is to be injected in such a flange region.

CN 113108622 A describes a cooling plate and a plate-shaped core and a plastic covering. The plate-shaped core has a porous metal plate.

Due to the porous structure, such a core can be designed to be significantly more stable, but is very expensive to manufacture.

Especially with regard to the use of a cooling plate as part of an intercell cooling element, a more robust and non-reformable design of the cooling plate is disadvantageous in principle. In particular, it would be very advantageous if such a cooling plate is at least partially compressible, in particular elastically compressible, with respect to the first direction, in order to be able to absorb swelling forces or to be able to compensate for the swelling of the adjacent battery cells. Swelling refers to the swelling of the battery cells in the course of their ageing as well as the cyclical swelling up and down of the battery cells during charging and discharging. Thus, the cooling plate should ideally be able to adapt to the changing intermediate space geometry to a certain extent. Accordingly, a rigid cooling plate is not suitable for compensating for such swelling.

The requirement to design such an intercell cooling element suitable for swelling compensation additionally contradicts the requirement to design the cooling plate as robust as possible for an injection molding process.

### SUMMARY

It is therefore the object of the present invention to provide an intercell cooling element, a battery module, a motor vehicle and a method which make it possible to design a cooling plate as robust as possible for an injection molding process for attaching a plastic component to the cooling plate and nevertheless to provide the intercell cooling element with the best possible swelling compensation properties.

This object is achieved by an intercell cooling element, a battery module, a motor vehicle, and a method. Advantageous embodiments of the invention are the subject matter of the claims, the description, and the figures.

An intercell cooling element according to the invention for arrangement between two cell rows, each having at least one battery cell, comprises a cooling plate, which comprises a first outer wall and a second outer wall opposite the same in a first direction, wherein an interior space is located between the first and second outer walls, in which interior space at least one cooling channel through which a cooling medium can flow is arranged, and wherein the intercell cooling element comprises at least one plastic component arranged on the outside of the cooling plate. A layered compression element that can be compressed in relation to the first direction is arranged in the interior of the cooling plate and a layered stiffening element that is less compressible than the compression element is arranged in a second direction next to the compression element and that is designed to support the first outer wall in some regions in relation to the second outer wall.

The layered compression element allows swelling compensation properties to be integrated particularly well into the intercell cooling element. By providing the additional layered stiffening element, it is advantageously possible to stiffen the cooling plate in regions, i.e. locally, and to support the two outer walls relative to one another in these regions. As a result, the cooling plate can be designed to be significantly more robust for an injection molding process for attaching the plastic component, without having to do without good swelling compensation properties. In particular, the stiffening element can protect the at least one cooling channel from being compressed by the forces acting on the cooling plate during an injection molding process. This thus counteracts deformation of the cooling plate overall when the plastic component is attached. The risk that the cooling plate is damaged or deformed during the injection molding process or, in general, during the attachment of the plastic component can be significantly reduced or eliminated completely as a result.

The cooling plate or its outer walls can be made of a metallic material. However, any other material is also suitable. The at least one cooling channel through which the cooling medium can flow can be designed as a cavity in the interior of the cooling plate. The cooling channel may be bounded by a channel wall. This can be provided, for example, in regions by one or both outer walls of the cooling plate itself and/or further optional structures located in the interior.

The layer of the compression element and the layer of the stiffening element are not arranged flat on top of each other in the first direction, but instead are arranged next to each other in the second direction. The layered compression element and the layered stiffening element lie, so to speak, essentially in the same plane perpendicular to the first direction. In addition, the compression element and/or the stiffening element need not be flat, but may also have a different shape, as will be explained in more detail later. The compression element and the stiffening element can optionally also be part of a same layer, which is formed in regions from materials that can be compressed differently. The compression element and the stiffening element can therefore be connected or joined to one another in a material-locking manner or represent separate components. In general, the stiffening element can be made of a different material than the compression element. The stiffening element and the compression element can be designed, for example, as layers which are separate from one another and can each be inserted into the interior of the cooling plate in the form of inserts. The at least one compression element and the at least one stiffening element can be regarded, for example, as a common intermediate layer which is arranged in the interior between a plurality of cooling channels. In other words, the at least one cooling channel can be located next to this intermediate layer with respect to the first direction. If the cooling plate comprises a plurality of cooling channels, these can only be arranged on one side or on both sides of this intermediate layer with respect to the first direction. In addition, the intermediate layer can extend substantially over the entire interior of the cooling plate with respect to the second direction, as well as with respect to a third direction, which can be defined perpendicularly to the first direction and perpendicularly to the second direction. The extension direction of the at least one cooling channel corresponds essentially to the second direction, the cooling channel not necessarily having to run in a straight line in the second direction.

The layered compression element is in particular a flat element or flat structure. The compression element has a thickness in the first direction, which represents the smallest dimension of the compression element. In other words, a length and a width of the compression element perpendicular to the first direction can be significantly greater than its thickness in the first direction. The compression element can be provided, for example, as a flat insert component with a substantially constant thickness. With respect to its initial shape, it can be essentially cuboid in the uninstalled state, i.e. have a rectangular geometry perpendicular to the first direction. It can also be flexible and, after installation in the interior, e.g. after insertion between the two outer walls, can also adapt to other geometries, e.g. to the wall geometry of the walls, in particular the boundary walls described below, which lie flat against the compression element. In addition, it is advantageous if the compression element can be compressed, in particular elastically compressed, with respect to the first direction. The cooling plate can thus be designed, in particular by the compression element and by flexible outer walls, in such a way that it can adapt at least in the cooling regions to changeable intermediate space geometries between two cell rows, in particular with provision of a certain restoring force.

The stiffening element is also layered, i.e. a flat structure. The stiffening element has a thickness in the first direction, which represents the smallest dimension of the stiffening element. In other words, a length and a width of the stiffening element perpendicular to the first direction can be significantly greater than its thickness in the first direction. The stiffening element can be provided, for example, as a flat insert component with a substantially constant thickness. The stiffening element has a higher stiffness and/or strength than the compression element. The stiffening element can nevertheless also be flexible and, for example, with regard to its initial shape in the uninstalled state, can be essentially cuboid in shape, i.e. have a rectangular geometry perpendicular to the first direction, and can also adapt to other geometries after installation in the interior, for example after insertion between the two outer walls, for example to the wall geometry of the walls, in particular of the boundary walls described below, which are in contact with the stiffening element in a flat manner. However, it is also possible that the stiffening element is not flexible or only slightly flexible. In this case, the stiffening element can already be formed with an initial geometry before the installation, which it also has in the interior after the installation. In addition, it is advantageous if the stiffening element is not compressible with respect to the first direction or is only slightly compressible. At least the stiffening element is preferably less compressible than the compression element.

The compression element can comprise, for example, one or more of the following materials:
polyurethane foam, silicone foam, EPDM (ethylene-propylene-diene rubbers), EVA (ethylene vinyl acetate) foam, cork.

The stiffening element can be formed from a material comprising one or more of the following materials: Any type of thermoplastics with or without filler material, such as glass fibers, any type of metallic materials, any type of thermosetting plastics.

In addition, the intercell cooling element can comprise a coolant supply connection and a coolant discharge connection, which are fluidically connected to the at least one cooling channel and via which a coolant can be supplied to the at least one cooling channel and can be discharged from the latter again. These connections can be arranged, for example, with respect to the second direction at opposite end regions of the intercell cooling element, in particular of the cooling plate. The connections can both also be arranged in the same end region or at any other location.

It is very advantageous, for example, if the compression element and/or the stiffening element or the above-mentioned intermediate layer extends in the third direction in a wave-shaped or zigzag-shaped manner. By such a wave-shaped or zigzag-shaped course, it is possible in a simple manner to provide that the compression element and/or stiffening element is arranged at least indirectly in regions on the inside of the first and second outer wall, and yet intermediate spaces are formed which can function as cooling channels. This represents an extremely space-saving option for integrating cooling channels into the interior.

According to a further advantageous embodiment of the invention, the cooling plate comprises two boundary walls which are arranged in the interior and between which the compression element and/or the stiffening element is arranged in a flat manner on the boundary walls, in particular wherein first cooling channels are formed between a first of the boundary walls and the first outer wall and second cooling channels are formed between a second of the boundary walls and the second outer wall, which are arranged offset in particular with respect to a third direction with respect to the first cooling channels, and wherein in particular the boundary walls and the compression element arranged between them, and in particular the stiffening element, run in the third direction in a wave-like or zigzag-like manner.

The compression element or the stiffening element and these two boundary walls can therefore have a kind of sandwich structure. For example, the compression element can be arranged between two boundary walls and the stiffening element can be arranged between two further separate boundary walls. This provides a compression component which is designed separately from the stiffening component, i.e. the compression element with the two boundary walls. However, it is particularly advantageous if the compression element and the stiffening element are arranged, for example, in the form of respective inserts between two common boundary walls. A respective one of these boundary walls can therefore extend continuously in the second direction and beyond the at least one compression element and the stiffening element.

In particular, one of the boundary walls and one of the outer walls can be designed as a one-piece component, e.g. as an extruded profile. The cooling plate can comprise, for example, two wall units, one of the wall units comprising one of the outer walls and one of the boundary walls. In this case, the boundary walls and the cavities located between the boundary walls and the outer walls, which cavities can represent the cooling channels, can be understood as part of the interior of the cooling plate.

The fact that, in addition, the first and second cooling channels are arranged offset to one another in the third direction can be provided in a simple manner by the above-described wave structure or the zigzag-shaped course of both the boundary walls and of the compression element and the stiffening element arranged between them. The two boundary walls can therefore extend parallel to one another and have a substantially constant distance with respect to the first direction to one another, at least in an uncompressed state of the cooling plate.

The first boundary wall can, for example, be adjacent to the first cooling channels and the second boundary wall to the second cooling channels, in particular wherein the first boundary wall contacts the first outer wall at first contact points point-wise and the second boundary wall contacts the second outer wall at second contact points point-wise. As a result, the first outer wall can advantageously be supported against the second outer wall via the boundary walls located in the interior and, above all, the stiffening element arranged between these boundary walls.

According to a further advantageous embodiment of the invention, the first outer wall has at least one first cooling region and a first frame region surrounding at least the first cooling region, wherein the plastic component comprises a first frame element which is arranged on the first outer wall in the first frame region. The plastic component can thus advantageously provide a frame function for the battery cell to be arranged in the first cooling region. With respect to a intended installation position of the intercell cooling element between two cell rows, the first cooling region then preferably lies flat against a cell housing side of a battery cell of such a cell row. The battery cell can then be correspondingly framed by the first frame element of the plastic component. The first frame element does not have to completely encircle the battery cell, but can also only partially or partially encircle it. The frame element can have recesses, for example, through which a part of the battery cell or other components of a battery module, for example cell connectors or pole connectors, can pass in order to electrically contact adjacent cells of the same cell row with one another. The first frame element can thus advantageously serve as a positioning aid for the battery cell to be accommodated and as a retaining device. In addition, it is possible to connect a plurality of such intercell cooling elements, which are arranged between respective cell rows of a battery module, to one another via the frame elements, for example to clip them together, in order thus to provide a stable overall composite. Alternatively or additionally, a housing function can be provided by the frame elements of a plurality of such intercell cooling elements, which are arranged between respective cell rows of a battery module, in the overall composite.

According to a further advantageous embodiment of the invention, the interior has at least one first spatial region which, with respect to the first direction, is opposite the first cooling region of the first outer wall, and at least one second spatial region which, with respect to the first direction, is opposite at least one first section of the first frame region of the first outer wall, and which, with respect to the second direction, is arranged next to the first spatial region, wherein the compression element is arranged in the first spatial region and the stiffening element is arranged in the second spatial region, in particular wherein the first frame region connects at least two longitudinal sections extending longitudinally in the second direction and the first section of the first frame region connects the at least two longitudinal sections to one another and extends longitudinally in a third direction.

The stiffening element is thus arranged in the interior precisely where at least a part of the first frame element provided by the plastic component is arranged on the outside of the first outer wall. During the production of the intercell cooling element and in particular during the attachment of the first frame element to the first outer wall, pressure is exerted on the cooling plate, for example in an injection molding process, precisely in the first frame region of the first outer wall and in particular in the first section of the first frame region of the outer wall. Thus, the cooling plate can advantageously be stiffened in this region by the stiffening element provided in the second spatial region, or it can be prevented from deforming or compressing.

In principle, it is also conceivable that the at least one stiffening element or optional further stiffening elements are arranged in a region of the interior, which are opposite the longitudinal sections of the first frame region with respect to the first direction, in order to also enable stiffening or support in the production process here. However, this is not absolutely necessary, in particular since the two outer walls are preferably joined to one another in a flange region at their respective edges opposite one another with respect to the third direction. The edge regions of the outer walls therefore lie directly on top of one another in this flange region and are joined to one another. These two flange regions, which are opposite one another with respect to the third direction and which extend correspondingly longitudinally in the second direction, can also simultaneously provide the longitudinal sections, which extend longitudinally in the second direction, of the first frame region of the first outer wall and of a corresponding second frame region of the second outer wall. In other words, to provide a frame, the corresponding plastic can be injection molded onto this flange region. No support is required in this flange region. Thus, with respect to the third direction, no stiffening element must be provided above and/or below the compression element.

It can therefore be provided that the two outer walls each comprise two edge regions which are opposite one another with respect to the third direction. For example, the first outer wall can comprise two first edge regions, which can be designed as ribs, for example, and the second outer wall can comprise two second edge regions, which can also be designed as ribs. A first and a second edge region are then respectively opposite each other in relation to the first direction, and in particular these are directly adjacent to each other and are joined to each other at least in some regions, for example welded. This joining region of the respective outer walls then preferably represents a part of the respective frame region of the two outer walls in that the longitudinal sections of the frame region are arranged.

The second outer wall can be formed in a corresponding way as described for the first outer wall For this reason, it is a further advantageous embodiment of the invention if the second outer wall has at least one second cooling region which, with respect to the first direction, is opposite the first cooling region of the first outer wall, and comprises a second frame region which surrounds at least the second cooling region and which, with respect to the first direction, is opposite the first frame region, wherein the plastic component comprises a second frame element which is arranged on the second outer wall in the second frame region and which is in particular formed integrally with the first frame element. The plastic component can comprise, for example, a frame which is subdivided into the first and the second frame element, wherein the first frame element is correspondingly arranged on the first outer wall and the second frame element is arranged on the second outer wall. This frame provided by the plastic component can in particular enclose or embrace the flange region or joining region described above, in which the first and second outer walls are joined to one another at the edges. As a result, the joining region can advantageously be additionally sealed by the frame. The frame can be designed as a one-piece injection molding component. The second cooling region, in turn, lies flat against a housing side of a battery cell with respect to the intended installation position of the intercell cooling element in a battery module. This battery cell can then be correspondingly framed by the second frame element, in particular completely or only partially or in sections.

The first spatial region is therefore arranged between the two cooling regions and the second spatial region is arranged between two sections of the respective first and second frame region which are opposite one another with respect to the first direction. Due to the fact that the compression element is arranged in the first spatial region, which is arranged between the two cooling regions, very good swelling compensation can be provided precisely in these regions, in which battery cells come to rest with respect to the intended installation position, due to the good compressibility of the compression element, in particular due to its elastically compressible properties. In addition, no frame part or no part of the plastic component is thus arranged in the respective cooling regions of the outer walls, so that these regions are not exposed to such great external forces during production in the injection molding process and accordingly no additional stiffening measures are required in the first spatial region of the interior. Thus, the cooling plate can be designed to be soft or compressible precisely in this region and with good swelling compensation properties.

Specifically in the second spatial region, which is arranged between the sections of the respective first and second frame region, a part of the frame provided by the plastic component is arranged on the outside of the respective outer walls, and correspondingly no part of a battery cell is directly in contact here. Accordingly, no swelling compensation must be provided in this region. For this reason, the stiffening element can advantageously be provided here, which ensures increased stability in the injection molding process, during which parts of the frame are attached precisely in these sections of the first and second frame region.

According to a further advantageous embodiment of the invention, the first outer wall has a plurality of first cooling regions which are spaced apart from one another in the second direction by a respective first section of the first frame region, wherein the first frame element is arranged on the first outer wall covering the first frame region, wherein the interior space in the second direction has a plurality of first spatial regions, each of which is opposite one of the first cooling regions of the first outer wall with respect to the first direction, and between which, in the second direction, there is in each case one of a plurality of second spatial regions of the interior space, which is opposite, with respect to the first direction, a respective one of a plurality of first sections of the first frame region of the first outer wall, wherein the cooling plate comprises a plurality of compression elements and stiffening elements, and wherein one of the compression elements is arranged in a respective first spatial region and one of the stiffening elements is arranged in a respective second spatial region.

The intercell cooling element is preferably used in a battery module which can comprise multiple cell rows. These cell rows are arranged next to one another with respect to the first direction, and such an intercell cooling element can be arranged between two respective cell rows arranged adjacent to one another. Each cell row can in turn comprise multiple battery cells, which are arranged adjacent to one another in the second direction. In this case, the battery cells of a same cell row do not face one another with their sides with the largest area, but rather, for example, with front sides of a respective battery cell, on which in each case one cell pole is located. Accordingly, it is very advantageous if the first outer wall comprises a plurality of cooling regions arranged next to one another in the second direction. Each cooling region can thus be assigned to a battery cell of the same cell row. The battery cells can be designed, for example, as prismatic battery cells or pouch cells. The housing sides of the battery cells, which then come to rest on the respective first cooling regions, are then essentially rectangular. Thus, the cooling regions can also have an essentially rectangular geometry. The battery cells of a same cell row can therefore be arranged with their cell poles facing one another and electrically contacted with one another via their cell poles. Thus, there is an intermediate region between two battery cells arranged adjacent to one another in the second direction, in which the cell poles are arranged, as well as, for example, contact elements for electrically contacting these two poles. No cell housing wall therefore extends in this intermediate region. Thus, the adjacent regions of the cooling plate do not have to be designed to be compressible. In principle, a cell row can comprise any number of battery cells, in particular more than two battery cells. Thus, for example, the first outer wall can alternately have a cooling region, a first section of the first frame region, again a cooling region, again a first section of the first frame region, a cooling region and so on in the second direction. The interior between the two outer sides can also be designed accordingly. In the second direction, this can therefore alternately have a first spatial region, a second spatial region, again a first spatial region, again a second spatial region and so on. The compression elements can be correspondingly provided in the first spatial regions and the stiffening elements can correspondingly be provided in the second spatial regions. In this way, the stiffening elements can be provided in the regions in which frame elements of the frame provided by the plastic component are provided and in which, at the same time, no swelling compensation has to be provided, which stiffening elements advantageously enable the two outer walls to be supported relative to one another during manufacture and prevent deformation of the cooling plate.

In addition, the second outer wall can also be designed in the same way as described for the first outer wall. This means that the second outer wall can also have a plurality of second cooling regions, which are arranged next to one another in the second direction and spaced from one another by a respective second section of the second frame region. The first and second cooling regions can be directly opposite one another with respect to the first direction, as well as the first and second sections of the respective first and second frame regions.

According to a further advantageous embodiment of the invention, the compression element and/or the stiffening element extend in the third direction substantially over the entire interior. The fact that these extend essentially over the entire interior with respect to the third direction is to be understood, for example, as meaning that there is preferably no free space between the compression element or the stiffening element and the first or second outer wall in and against the third direction, but rather at most retaining elements and/or parts of the above-mentioned boundary walls, via which the compression element or the stiffening element is connected to the outer walls or is retained in the interior. In particular, it is very advantageous here if, above all, the compression element extends essentially over the entire interior with respect to the third direction. In other words, in the third direction above or below the compression element, no further stiffening element must be provided. This can in turn be achieved by providing longitudinal frame sections of the frame in the flange region described above, in which the two outer walls are joined together and abut directly against each other.

Furthermore, the invention also relates to a battery module having a intercell cooling element according to the invention or one of its embodiments.

The battery module can be designed in particular, as already described above in connection with the intercell cooling element according to the invention or its configurations. In addition, the battery module can also comprise multiple intercell cooling elements.

The battery module can be designed as a battery, in particular as a high-voltage battery, or can be part of a battery, in particular part of a high-voltage battery. This can be a traction battery for a motor vehicle.

Furthermore, the invention also relates to a motor vehicle with a battery module according to the invention or one of its embodiments. The motor vehicle can be designed as an electric vehicle, for example.

The motor vehicle according to the invention is preferably designed as an automobile, in particular as a passenger car or truck, or as a passenger bus or motorcycle.

The invention also relates to a method for producing an intercell cooling element for arrangement between two cell rows, each having at least one battery cell, wherein a cooling plate is provided, which comprises a first outer wall and a second outer wall opposite the same in a first direction, wherein an interior space is located between the first and second outer walls, in which interior space at least one cooling channel through which a cooling medium can flow is arranged, and wherein a plastic component is injection molded on the outside of the cooling plate in an injection molding process. In this process, before the plastic component is injection molded, the cooling plate is provided with a layered compression element located in the interior, which is compressible in the first direction, and with a layered stiffening element arranged next to the compression element in a second direction, which is less compressible than the compression element, and by means of which the first outer wall is supported relative to the second outer wall during injection molding of the plastic component.

The fact that the first outer wall is supported with respect to the second outer wall by means of the stiffening element is to be understood here as meaning that the stiffening element is designed to generate a corresponding restoring force on the two outer walls when an external force is applied to the outer walls. In particular, the stiffening element is designed such that the outer walls in the region of the stiffening element are not deformed towards each other during the injection molding process.

According to a further advantageous embodiment of the invention, the at least one cooling channel is at least partially or completely filled with a fluid, for example a liquid or a gas, for example compressed air, during the injection molding of the plastic component, or such a fluid flows through it during the injection molding of the plastic component. As a result, the at least one cooling channel can also be stabilized from the inside during injection molding of the plastic component. This generally applies analogously to the optional further cooling channels of the cooling plate.

The invention also includes further developments of the method according to the invention, which have features as already described in connection with the further developments of the intercell cooling element, the battery module and the motor vehicle according to the invention. For this reason, the corresponding developments of the method according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic representation of a part of a battery module in an exploded view according to an exemplary embodiment of the invention;

FIG. 2 shows a perspective illustration of the part of the battery module from FIG. 1 according to an exemplary embodiment of the invention;

FIG. 3 shows a schematic exploded representation of a part of an intercell cooling element having a cooling plate according to an exemplary embodiment of the invention;

FIG. 4 shows a perspective and open illustration of an intercell cooling element according to an exemplary embodiment of the invention;

FIG. 5 shows a schematic cross-sectional illustration of a cooling plate for an intercell cooling element in the region of the compression element according to an exemplary embodiment of the invention;

FIG. 6 shows a schematic cross-sectional representation of a cooling plate for an intercell cooling element in the region of the stiffening element according to an exemplary embodiment of the invention; and

FIG. 7 shows a schematic representation of an intercell cooling element arranged in an injection molding tool during production according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, same reference numerals respectively designate elements that have the same function.

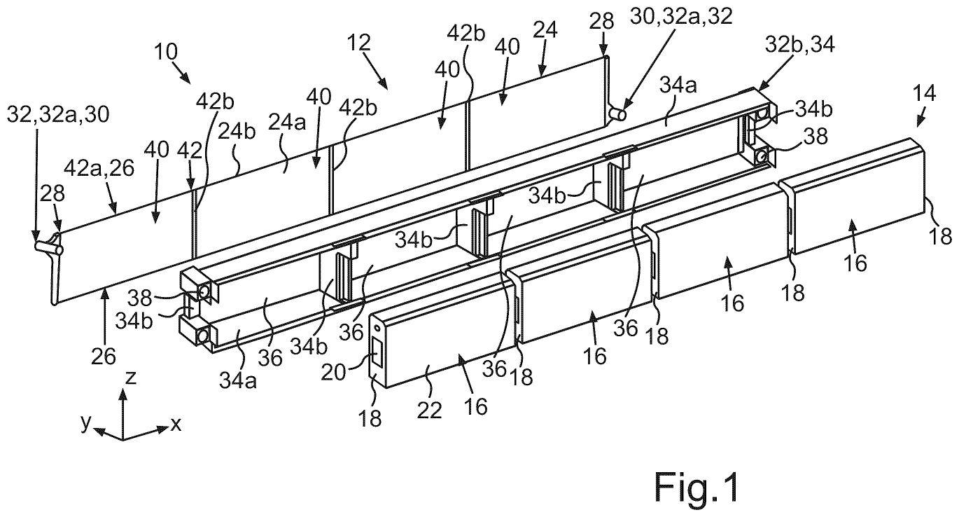

FIG. 1 shows a schematic exploded representation of a part of a battery module 10 with an intercell cooling element 12 according to an exemplary embodiment of the invention. In addition to the intercell cooling element 12, a cell row 14 with multiple battery cells 16 arranged next to each other in the x direction shown is also shown. The respective end faces 18 of the battery cells 16, on each of which a cell pole 20 is arranged, face each other in the x-direction. The largest housing sides of the respective battery cells 16 in terms of area are designated by 22. Each cell 16 has two such sides 22, which are largest in terms of area and which are opposite one another in the x direction shown, which was also previously referred to as the first direction. The x direction was previously referred to as the second direction and the z direction shown as the third direction.

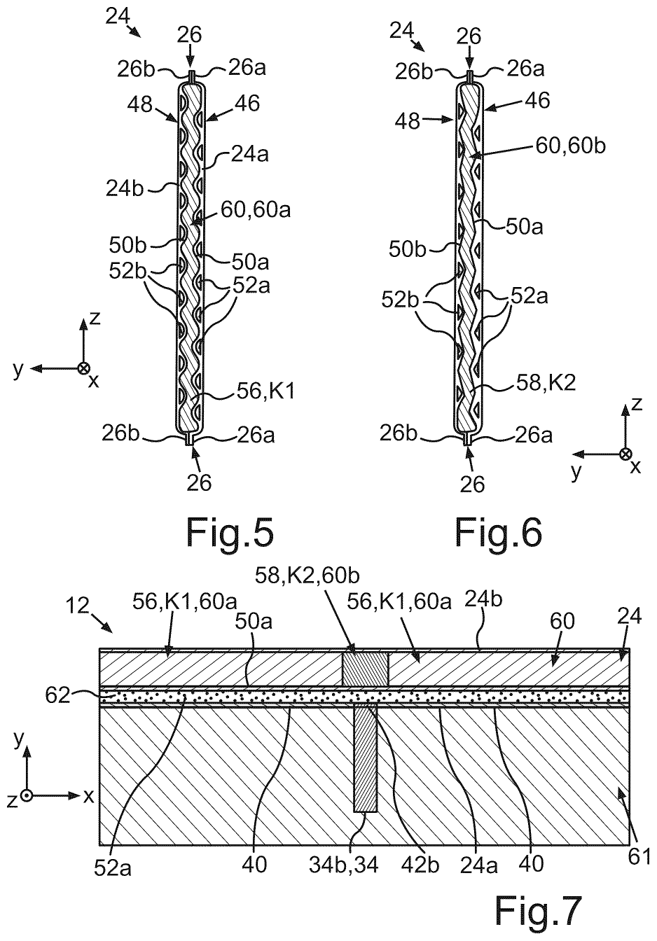

The intercell cooling element 12 now comprises a cooling plate 24. For this purpose, one or more cooling channels can be integrated into the cooling plate 24, as explained in more detail later. The cooling plate 24 comprises two outer walls 24a, 24b which are opposite one another with respect to the y-direction and which are joined to one another, for example welded to one another, in two edge regions 26 which are opposite one another with respect to the z-direction and extend in the x-direction. These edge regions 26 are therefore also referred to as joining regions 26 or flange regions 26. A respective outer wall 24a, 24b can provide a corresponding rib 26a, 26b (compare FIG. 5, for example) for welding in this edge region 26. In the end regions 28 of the cooling plate 24 which are opposite with respect to the x-direction, the cooling plate may be open. Connecting elements 30 may be attached to these end regions 28. It is particularly advantageous if these are injection molded onto the end regions 28 in an injection molding process made of plastic. In particular, these connections 30 may be part 32a of a plastic component 32 which is attached to the cooling plate 24 in an injection molding process. In addition or alternatively, a frame 34 can also be injection molded onto the cooling plate 24 as part 32b of such a plastic component 32. The frame 34 is preferably attached to the cooling plate 24 in such a way that longitudinal sections 34a of the frame 34, which extend longitudinally in the x-direction, surround or cover the edge regions 26. Thus, the injection-molded frame 34 can simultaneously provide an additional seal of the joining region 26 of the two outer walls 24a, 24b. However, additional functions can be provided by the frame 34. In addition to the longitudinal frame sections 34a, the frame 34 can also comprise connecting webs 34b which connect the longitudinal sections 34a to one another and which can also be referred to as separating webs 34b or intermediate webs 34b. A receiving region 36 for receiving a respective battery cell 16 is provided in each case between two connecting webs 34b adjacent to one another in the x-direction. The battery cells 16 can be positioned and held via the frame 34 when arranged on the intercell cooling element 12. In the region of the connecting webs 34b, the frame 34 can be designed with recesses in order to make contact with the cell poles 20 of cells 16 adjacent to one another in the x-direction. The connections 30 can also be produced in one piece with the frame 34 in an injection molding process or can be designed as separate components, in particular also as part of the cooling plate 24. The frame 34 can also comprise suitable coolant supply and discharge connections 38, via which coolant can be introduced into the cooling plate 24, which is ultimately arranged in or on the frame 34, and can be discharged from the latter again, and to which the connections 30 can be connected.

In an injection molding process, the frame 34 can now be attached to the cooling plate 24 in such a way that a part of the frame 34, which can also be referred to as the first frame element, is attached to the first outer wall 24a, and a further part of the frame 34, which was previously also referred to as the second frame element and adjoins the first frame element in the y direction, is attached to the second outer wall 24b. The two frame elements do not have to be of the same size, mirror-symmetrical or the like. For example, the second frame element can also be limited to only a small part of the frame 34, which ultimately abuts on the second outer wall 24b, for example only on the rib 26b (compare FIG. 5) of the edge region 26. It is also conceivable that the entire frame 34 is only injection molded onto one of the two outer walls 24a, 24b, in this case for example the first outer wall 24a.

The first outer wall 24a can be divided into several regions for easier description. For example, this may comprise a plurality of cooling regions 40, in the present example four cooling regions 40, which, when the frame 34 is arranged as intended on the cooling plate 24, are not covered by the frame 34 and on which the housing sides 22 of the cells 16, when these are arranged as intended on the intercell cooling element 12, lie flat. In addition, the first outer wall 24a comprises a first frame region 42. This comprises all regions of the first outer wall 24a on which the frame 34 abuts on the cooling plate 24 when arranged as intended. The frame region 42 can in turn be subdivided into several partial regions. The frame region 42 in turn comprises longitudinal sections 42a extending in the x-direction, which are provided in the present case by the edge regions 26 or the rib 26a of this edge region 26 of the first outer wall 24a, as well as first sections 42b, which connect the longitudinal sections 40a to one another, extend longitudinally in the z-direction and correspond to the intermediate webs 34b of the frame 34. In other words, when the frame 34 is arranged as intended on the cooling plate 24, the separating webs 34b are in contact with these first sections 42b of the frame region 42 of the first outer wall 24a. For the second outer wall 24b, the same regions can be defined in a very analogous manner.

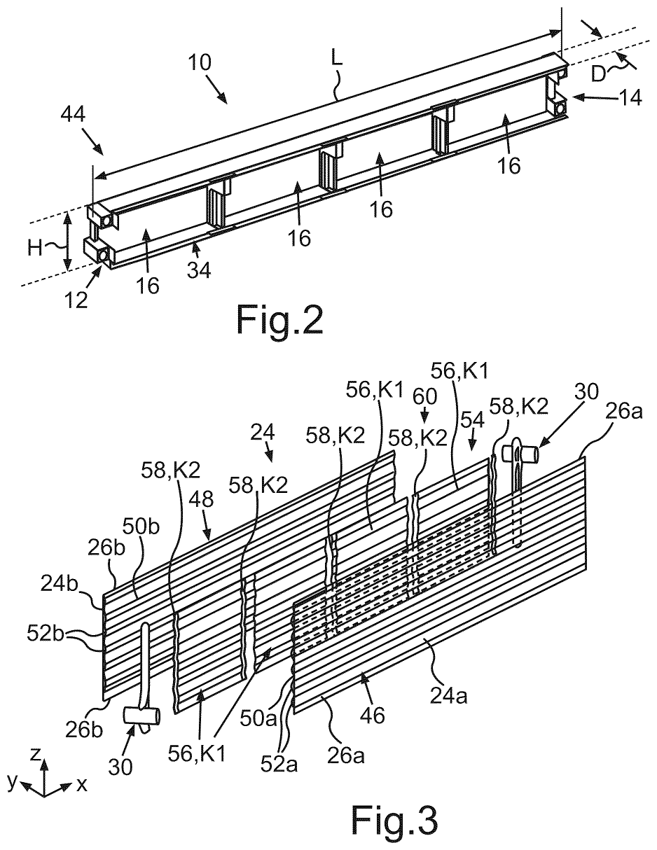

FIG. 2 again shows a perspective representation of the part of the battery module 10 from FIG. 1. The cell row 14 is now arranged on the intercell cooling element 12 as intended. As can be seen, a respective battery cell 16 is framed by the frame 34.

This illustrated part of the battery module 10, i.e. the intercell cooling element 12 together with a cell row 14, can have, by way of example, a total length L in the x direction of 1133 mm, a height H in the z direction of 113 mm and a thickness D in the x direction of 36 mm. In order to form a battery module 10, a plurality of such cell cooling units 44, which thus each comprise an intercell cooling element 12 and a cell row 14, can be lined up in or opposite to the y direction and connected to one another, for example, can be plugged together, clipped, clamped with clamping straps or the like. This can provide a high-voltage battery.

If the described frame 34 is now to be injection molded onto a cooling plate 24 in an injection molding process, forces act on the cooling plate 24 from the outside. In the case of conventional plates, the problem arises, especially if they comprise cavities in the interior, for example for providing cooling channels, that the plates are deformed in the process and the plastic, during injection molding, reaches regions into which it should not pass.

Since the present cooling unit is to be used as an intercell element 12 between battery cells 16, many measures which can ensure greater robustness in the injection molding process are not possible in the present case, for example a more rigid design of the cooling plate 24 or the like. This is due in particular to the fact that the cooling plate 24, due to its position between the cells 16, is not only used for cooling the cells 16, but also has to absorb a certain expansion and swelling of the cells 16 during swelling, i.e. should ideally be flexible or elastically compressible in the y direction in order to be able to compensate for such swelling. The invention and its embodiments now advantageously make it possible to equip the cooling plate 24 on the one hand with good swelling compensation properties and on the other hand also sufficiently rigid or robust so that it is not unintentionally deformed in an injection molding process. This will now be explained in more detail with reference to FIG. 3.

FIG. 3 shows a schematic exploded view of the cooling plate 24 for an intercell cooling element 12 with the additionally shown connections 30 according to an embodiment of the invention. The cooling plate 24 comprises a first wall unit 46 and a second wall unit 48. The first wall unit 46 comprises, on the one hand, the first outer wall 24a already mentioned and a boundary wall 50a. First cooling channels 52a are formed between the first outer wall 24a and the first boundary wall 50a. The first wall unit 48 is constructed in the same way. This thus comprises the second outer wall 24b, a second boundary wall 50b, wherein second cooling channels 52b are formed between the second outer wall 24b and the second boundary wall 50b. For this purpose, the respective boundary walls 50a may in particular be wave-shaped or zigzag-shaped. The respective outer walls 24a, 24b, on the other hand, can be flat and, in particular, have flat surfaces on the outside in order to enable flat contact with the adjacent battery cells 16.

An intermediate layer 54 is arranged between the two wall units 46, 48. This can be made in one piece or in several pieces. In a one-piece design, the intermediate layer 54 has at least different regions with different material properties. However, these different regions can also be provided as separate layer elements, for example in the form of flat inserts. In the present example, this layer 54 therefore comprises a plurality of layered compression elements 56 which are arranged next to one another in the x direction, a stiffening element 58 being located between each compression element 56 arranged next to one another in the x direction. Such stiffening elements 58 can also be provided at the edge side in and opposite to the x-direction at the end of the layer 54. The compression layer or the compression element 56 has a first compressibility K1 which is higher, in particular significantly higher, than a second compressibility K2 of these stiffening elements 58. In particular, the stiffening elements 58 may also be designed to be substantially incompressible.

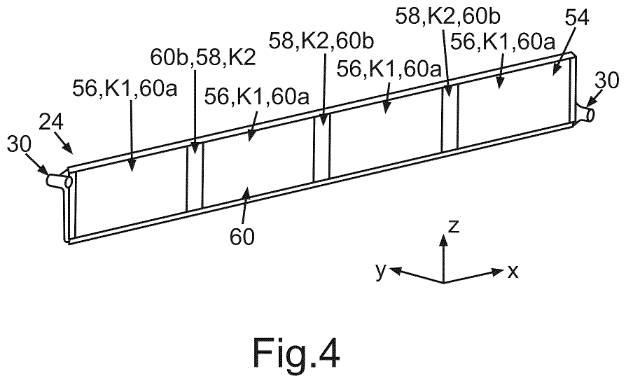

If the outer walls 24a, 24b are arranged together as intended, they enclose an interior 60. The cooling channels 52a, 52b formed between the respective outer walls 24a, 24b and the boundary walls 50a, 50b are also to be considered as part of this interior 60. This interior 60 can now be subdivided, mainly in the x-direction, into different interior regions, namely first interior regions 60a and second interior regions 60b (compare FIG. 4).

FIG. 4 again shows a perspective representation of the cooling plate 24 in open form, i.e. without the first wall unit 46 shown. Thus, the interior 60 with the intermediate layer 54 arranged therein can be seen. The compression elements 56 are arranged in the first spatial regions 60a, and the stiffening elements 58 in the second spatial regions 60b. The first spatial regions 60a are in turn directly opposite the cooling regions 40 of the first outer wall 24a with respect to the x-direction, and the second spatial regions 60b are directly opposite the first sections 42b of the frame region 42 of the first outer wall 24a. In other words, the stiffening elements 58 are arranged precisely in those regions in the interior 60 which correspond to the outer regions of the outer wall 24a at which the frame 34, more precisely the intermediate webs 34b of the frame 34, are arranged or injection molded in the injection molding process. On the one hand, no swelling compensation is required here, i.e. no flexibility of the cooling plate 24 is required, since no cells 16 are present in these regions, and, moreover, the application of force to the cooling plate 24 by the injection molding of the corresponding frame parts is very high here, especially in the injection molding process. As a result, by providing the stiffening elements 58, a higher rigidity of the cooling plate 24 and a higher robustness in the injection molding process can be achieved in these regions, as a result of which deformations of the cooling plate 24 in the injection molding process can be prevented without impairing the compression properties or the good swelling compensation properties.

FIG. 5 shows a schematic cross-sectional representation of the cooling plate 24 in a cross-section perpendicular to the x-direction in a region of a compression element 56, and FIG. 6 shows a schematic cross-sectional representation of the cooling plate 24 in a cross-section perpendicular to the x-direction in the region of one of the stiffening elements 58.

In particular, the first cooling channels 52a and second cooling channels 52b formed between the outer walls 24a, 24b and the respective boundary walls 50a, 50b are also to be seen here. The cooling channels 52a are offset in the z-direction with respect to the second cooling channels 52b, which is due in particular to the wave-shaped or zigzag-shaped structure of the boundary walls 50a, 50b and the compression element 56 or stiffening element 58 arranged between them. This permits a particularly space-saving arrangement and at the same time a very advantageous support of the outer walls 24a, 24b relative to one another, especially in the region of the stiffening element 58. By way of example, the cooling plate 24, the cross-section of which is shown in the region of the compression element 56, is designed with a wave-shaped structure of the boundary walls 50a, 50b and of the compression element 56 arranged therebetween, while the cooling plate 24, the cross-section of which is shown in the region of the stiffening element 58, is designed with a zigzag-shaped structure of the boundary walls 50a, 50b and of the stiffening element 58 arranged therebetween. This is intended to illustrate any design options. Preferably, the cooling plate 24 is either designed with a wave-shaped structure of the boundary walls 50a, 50b and the compression elements 56 arranged between them as well as the stiffening elements 58 or is designed uniformly with a zigzag-shaped structure.

The compression element 56 and the stiffening element 58 preferably extend in the z-direction substantially over the entire interior 60.

The first wall unit 46 and the first wall unit 48 can each be designed as a one-piece component, for example as an extruded profile. However, there is also another production option.

FIG. 7 shows a schematic representation of an intercell cooling element 12 in an injection molding tool 61 during manufacture, in particular during the injection molding of the frame part 34b of the frame 34 onto the outer wall 24a of the cooling plate 24. In this example, the cooling plate 24 comprises an interior 60 in which at least one cooling channel 52a extends and which is formed between a boundary wall 50a on the first outer wall 24a. In the x-direction, the interior 60 is subdivided into first interior regions 60a in which the compression element 56 is arranged and second interior regions 60b in which the stiffening element 58 is arranged. The second spatial regions 60b are located directly opposite the first sections 42b of the frame region 42 of the first outer wall 24a with respect to the y direction. The first spatial regions 60a are located directly opposite the cooling regions 40 of the outer wall 24a with respect to the y direction. It is precisely in the region in which a part 34b of the frame 34 is injection molded in the injection molding process that increased rigidity and strength of the cooling plate 24 can be provided by providing the stiffening element 58 in the corresponding second spatial region 60b. It is also possible to fill or flow through the cooling channels 52a with a fluid 62 during the injection molding process. This prevents compression of the cooling channels 52a by the external application of force occurring during the injection molding process.

The outer walls 24a, 24b and the boundary walls 50a, 50b may be made of aluminum, for example. The connections 30 can be made of aluminum die-cast or manufactured as plastic injection molded parts. The layered compression elements can be made of PU foam or EVA foam, for example. The stiffening elements can be made of polyamide, for example PA6GF30.

To produce the intercell cooling element 12, the following procedure can be followed, for example: First, the aluminum profiles providing the respective wall units 46, 48 can be cut to size, in particular with respect to their length in the x direction, for example by means of milling, sawing and so on. The swelling pads provided by the compression elements 56 and the stiffenings, i.e. the stiffening elements 58, can then be positioned on the inside of one of the boundary walls 50a, 50b, for example the second boundary wall 50b, and optionally fixed, for example glued on. The other of the two wall units 46, 48 can then be placed and pressed on so that the compression elements 56 and stiffening elements 58 are enclosed in a flat manner between the two boundary walls 50a, 50b, in particular enclosed in the interior 60 of the cooling plate 24.

The two wall units 46, 48 can also advantageously be designed as identical parts, and one of the two wall units 46, 48 can be positioned rotated by 180 degrees relative to the other during assembly. In other words, the two wall units 46, 48 can be identical in design, but can only be rotated relative to one another with respect to their position during assembly.

The two wall units 46, 48 can be pressed against each other until their respective ribs 26a, 26b are in contact at the top and bottom. The wall units can then be sealed at their ribs 26a, 26b, for example by means of a laser. The water tanks with the connections 30 can then be plugged onto the profile at the end, i.e. the cooling plate 24, and welded all around with laser in a leak-tight manner to the cooling plate 24 or additionally or alternatively bonded. The cooling body provided in this way can then be cleaned or washed and subjected to a leak tightness and leakage test. Subsequently, as already described, the frame 34 can be injection molded onto the cooling plate 24.

Overall, the examples show how the invention can provide a structure of a cooling body between prismatic cells. By using a material or a material combination that has a variable hardness over the surface, the mechanical stiffness can be adapted to the different requirements via the surface variable. A distinction can be made here, for example, between regions with a supporting function which are subjected to increased load once during the production process and regions which are subjected to changing load cyclically during loading and unloading (swelling). In order to avoid deformation of the cooling channels during the injection molding process, it is also advantageous if the cooling plates during this time are completely filled with an incompressible fluid or with a fluid under very high pressure.

1. An intercell cooling element for arrangement between two cell rows, each having at least one battery cell,
wherein the intercell cooling element comprises a cooling plate comprising a first outer wall and a second outer wall opposite the same in a first direction,
wherein an interior space is located between the first and second outer walls, in which interior space at least one cooling channel through which a cooling medium can flow is arranged,
wherein the intercell cooling element comprises at least one plastic component arranged on the outside of the cooling plate,
wherein a layered compression element compressible in the first direction is arranged in the interior of the cooling plate, and a layered stiffening element less compressible than the compression element is arranged in a second direction adjacent to the compression element and is designed to support the first outer wall in some regions relative to the second outer wall.

2. The intercell cooling element according to claim 1, wherein the cooling plate comprises two boundary walls which are arranged in the interior space and between which the compression element and/or the stiffening element is arranged in a flat manner adjacent to the boundary walls, in particular wherein first cooling channels are formed between a first boundary wall of the boundary walls and the first outer wall, and second cooling channels are formed between a second boundary wall of the boundary walls and the second outer wall, which are offset in particular with respect to a third direction to the first cooling channels, and in particular the boundary walls and the compression element arranged between them, as well as in particular the stiffening element, run in a wave-like or zigzag-like manner in the third direction.

3. The intercell cooling element according to claim 1, wherein the first outer wall has at least one first cooling region and a first frame region surrounding at least the first cooling region, wherein the plastic component comprises a first frame element which is arranged on the first outer wall in the first frame region.

4. The intercell cooling element according to claim 1, wherein the interior space has at least one first spatial region which, with respect to the first direction, is opposite the first cooling region of the first outer wall, and has at least one second spatial region which, with respect to the first direction, is opposite at least one first section of the first frame region of the first outer wall, and which is arranged adjacent to the first spatial region with respect to the second direction, wherein the compression element is arranged in the first spatial region and the stiffening element is arranged in the second spatial region, in particular wherein the first frame section has at least two longitudinal sections extending longitudinally in the second direction, and the first section of the first frame section connects the at least two longitudinal sections to each other and extends longitudinally in a third direction.

5. The intercell cooling element according to claim 1, wherein the second outer wall has at least one second cooling region which, with respect to the first direction, is opposite the first cooling region of the first outer wall, and a second frame region which surrounds at least the second cooling region and, with respect to the first direction, is opposite the first frame region, wherein the plastic component comprises a second frame element which is arranged on the second outer wall in the second frame region and which is in particular formed integrally with the first frame element.

6. The intercell cooling element according to claim 1, wherein the first outer wall has a plurality of first cooling regions which are arranged next to each other in the second direction and are spaced apart from each other by a respective first section of the first frame region, wherein the first frame element is arranged on the first outer wall covering the first frame region, wherein the interior space has a plurality of first space regions in the second direction, each of which is opposite one of the first cooling regions of the first outer wall with respect to the first direction, and between which there is, in the second direction, one of a plurality of second space regions of the interior space, which is opposite a respective one of a plurality of first sections of the first frame region of the first outer wall with respect to the first direction, wherein the cooling plate comprises a plurality of compression elements and stiffening elements, wherein in a respective first space region a respective one of the compression elements is arranged and in a respective second spatial region a respective one of the stiffening elements is arranged.

7. The intercell cooling element according to claim 1, wherein the compression element and/or the stiffening element extend in the third direction essentially across the entire interior space.

8. A battery module with an intercell cooling element according to claim 1.

9. A motor vehicle having a battery module according to claim 8.

10. A method for producing an intercell cooling element for arrangement between two cell rows with at least one respective battery cell,
wherein a cooling plate is provided, comprising a first outer wall and a second outer wall opposite the same in a first direction,
wherein an interior space is located between the first and second outer walls, in which interior space at least one cooling channel through which a cooling medium can flow is arranged,
wherein a plastic component is injection molded onto the outside of the cooling plate in an injection molding process,
wherein the cooling plate is provided, before the injection molding of the plastic component, with a layered compression element located in the interior, compressible in the first direction, and with a layered stiffening element arranged in a second direction next to the compression element, which is less compressible than the compression element, and by which, during the injection molding of the plastic component, the first outer wall is supported relative to the second outer wall.

11. The intercell cooling element according to claim 2, wherein the first outer wall has at least one first cooling region and a first frame region surrounding at least the first cooling region, wherein the plastic component comprises a first frame element which is arranged on the first outer wall in the first frame region.

12. The intercell cooling element according to claim 2, wherein the interior space has at least one first spatial region which, with respect to the first direction, is opposite the first cooling region of the first outer wall, and has at least one second spatial region which, with respect to the first direction, is opposite at least one first section of the first frame region of the first outer wall, and which is arranged adjacent to the first spatial region with respect to the second direction, wherein the compression element is arranged in the first spatial region and the stiffening element is arranged in the second spatial region, in particular wherein the first frame section has at least two longitudinal sections extending longitudinally in the second direction, and the first section of the first frame section connects the at least two longitudinal sections to each other and extends longitudinally in a third direction.

13. The intercell cooling element according to claim 3, wherein the interior space has at least one first spatial region which, with respect to the first direction, is opposite the first cooling region of the first outer wall, and has at least one second spatial region which, with respect to the first direction, is opposite at least one first section of the first frame region of the first outer wall, and which is arranged adjacent to the first spatial region with respect to the second direction, wherein the compression element is arranged in the first spatial region and the stiffening element is arranged in the second spatial region, in particular wherein the first frame section has at least two longitudinal sections extending longitudinally in the second direction, and the first section of the first frame section connects the at least two longitudinal sections to each other and extends longitudinally in a third direction.

14. The intercell cooling element according to claim 2, wherein the second outer wall has at least one second cooling region which, with respect to the first direction, is opposite the first cooling region of the first outer wall, and a second frame region which surrounds at least the second cooling region and, with respect to the first direction, is opposite the first frame region, wherein the plastic component comprises a second frame element which is arranged on the second outer wall in the second frame region and which is in particular formed integrally with the first frame element.

15. The intercell cooling element according to claim 3, wherein the second outer wall has at least one second cooling region which, with respect to the first direction, is opposite the first cooling region of the first outer wall, and a second frame region which surrounds at least the second cooling region and, with respect to the first direction, is opposite the first frame region, wherein the plastic component comprises a second frame element which is arranged on the second outer wall in the second frame region and which is in particular formed integrally with the first frame element.

16. The intercell cooling element according to claim 4, wherein the second outer wall has at least one second cooling region which, with respect to the first direction, is opposite the first cooling region of the first outer wall, and a second frame region which surrounds at least the second cooling region and, with respect to the first direction, is opposite the first frame region, wherein the plastic component comprises a second frame element which is arranged on the second outer wall in the second frame region and which is in particular formed integrally with the first frame element.

17. The intercell cooling element according to claim 2, wherein the first outer wall has a plurality of first cooling regions which are arranged next to each other in the second direction and are spaced apart from each other by a respective first section of the first frame region, wherein the first frame element is arranged on the first outer wall covering the first frame region, wherein the interior space has a plurality of first space regions in the second direction, each of which is opposite one of the first cooling regions of the first outer wall with respect to the first direction, and between which there is, in the second direction, one of a plurality of second space regions of the interior space, which is opposite a respective one of a plurality of first sections of the first frame region of the first outer wall with respect to the first direction, wherein the cooling plate comprises a plurality of compression elements and stiffening elements, wherein in a respective first space region a respective one of the compression elements is arranged and in a respective second spatial region a respective one of the stiffening elements is arranged.

18. The intercell cooling element according to claim 3, wherein the first outer wall has a plurality of first cooling regions which are arranged next to each other in the second direction and are spaced apart from each other by a respective first section of the first frame region, wherein the first frame element is arranged on the first outer wall covering the first frame region, wherein the interior space has a plurality of first space regions in the second direction, each of which is opposite one of the first cooling regions of the first outer wall with respect to the first direction, and between which there is, in the second direction, one of a plurality of second space regions of the interior space, which is opposite a respective one of a plurality of first sections of the first frame region of the first outer wall with respect to the first direction, wherein the cooling plate comprises a plurality of compression elements and stiffening elements, wherein in a respective first space region a respective one of the compression elements is arranged and in a respective second spatial region a respective one of the stiffening elements is arranged.

19. The intercell cooling element according to claim 4, wherein the first outer wall has a plurality of first cooling regions which are arranged next to each other in the second direction and are spaced apart from each other by a respective first section of the first frame region, wherein the first frame element is arranged on the first outer wall covering the first frame region, wherein the interior space has a plurality of first space regions in the second direction, each of which is opposite one of the first cooling regions of the first outer wall with respect to the first direction, and between which there is, in the second direction, one of a plurality of second space regions of the interior space, which is opposite a respective one of a plurality of first sections of the first frame region of the first outer wall with respect to the first direction, wherein the cooling plate comprises a plurality of compression elements and stiffening elements, wherein in a respective first space region a respective one of the compression elements is arranged and in a respective second spatial region a respective one of the stiffening elements is arranged.

20. The intercell cooling element according to claim 5, wherein the first outer wall has a plurality of first cooling regions which are arranged next to each other in the second direction and are spaced apart from each other by a respective first section of the first frame region, wherein the first frame element is arranged on the first outer wall covering the first frame region, wherein the interior space has a plurality of first space regions in the second direction, each of which is opposite one of the first cooling regions of the first outer wall with respect to the first direction, and between which there is, in the second direction, one of a plurality of second space regions of the interior space, which is opposite a respective one of a plurality of first sections of the first frame region of the first outer wall with respect to the first direction, wherein the cooling plate comprises a plurality of compression elements and stiffening elements, wherein in a respective first space region a respective one of the compression elements is arranged and in a respective second spatial region a respective one of the stiffening elements is arranged.
